(19) United States
(12) Patent Application Publication
(10) Pub. No.: US 2007/0185793 A1
(43) Pub. Date: Aug. 9, 2007

(54) Method and computer network for coordinating a financial, insurance, investment, business service over the Internet

(76) Inventor: Christopher Robert George, Rocklin, CA (US)

Correspondence Address: CHRISTOPHER GEORGE, 6351 BLUEBILL CT., ROCKLIN, CA, 95765, US

(21) Appl. No.: 11/307,488

(22) Filed: Feb. 9, 2006

(51) Int. Cl. G06Q 40/00

(52) U.S. Cl. 705/35

(57) ABSTRACT

The invention relates to a method and a computer for coordinating an electronic application between a company and a plurality of financial, insurance, investment and business service institutions via the Internet. This method involves displaying documents in a web site, and receiving financial, business structure, industry, Paydex Score and credit data forming placed on the web site. After receiving this data a special processing computer applies a filter to the data. The filter comprises product selection criteria provided by financial, insurance, investment and business service institutions which allows these institutions to filter out the applications that they do not want. Next, after the data is filtered, it is transmitted to a plurality of financial, insurance, investment and business service institutions. Finally, the computer and the method then controls and coordinates communication between these financial, insurance, investment and business service institutions and the company to match businesses and vendors via the Internet.

### BACKGROUND OF THE INVENTION

1. The Field of the Invention

The invention relates to a process for coordinating Commercial real estate loan, commercial line of credit, commercial letter of credit, commercial equipment lease, Accounts Receivable Financing, Corporate Credit Card, Merchant Services, 1031 exchange, investment, Directors & Officers Insurance, Errors & Omissions Insurance, Workers Comp. Insurance, Employee Benefit Plans, Cafeteria Plans, Screening & Selection Services, Payroll Services, etc. processing computer over the Internet. The Internet, a vast collection of computers world wide, is a relatively new medium for both personal and commercial entities to transact business. To conduct business over the Internet, companies must find ways to communicate with potential customers. The two most common forms of communication across the Internet are web pages, and e-mail.

2. The Prior Art

Various methods are known for presenting web pages over the Internet. For example, information about the Internet and web browsers can be found in U.S. Pat. No. 5,701,451 to Rogers et al., which is incorporated herein by reference. Rogers et al., details how requests of a web browser are processed. The Rogers invention speeds up the process for receiving requests from web browser users and retrieving the required information. U.S. Pat. No. 5,535,407 to Yanagawa et al., details a customer data processing system which is used to assist credit card purchases made in stores. The Yanagawa invention simplifies the way in which credit card purchases are verified at the time of checkout. U.S. Pat. No. 4,346,442 to Musmanno details a securities brokerage-cash management system. The Musmanno invention maintains customer brokerage accounts, charge cards and checking accounts and calculates available credit for purchases of securities.

Until now, there has been no way to apply for Commercial real estate loan, commercial line of credit, commercial letter of credit, commercial equipment lease, Accounts Receivable Financing, Corporate Credit Card, Merchant Services, 1031 exchange, investment, Directors & Officers Insurance, Errors & Omissions Insurance, Workers Comp. Insurance, Employee Benefit Plans, Cafeteria Plans, Screening & Selection Services, Payroll Services, etc. from a multitude of financial, insurance, investment and business service institutions without physically going to or calling each institution and filling out an application. This process was tedious and time consuming. All applications required substantially the same information: Company name, address, structure, industry, cash flow, facility requested, etc. This invention combines the vast resources and speed of the Internet with additional knowledge of various financial, insurance, investment and business service institution's selection criteria to create a simple mechanism whereby a company can apply for financial, insurance, investment and business services from a multitude of financial, insurance, investment and business service institutions.

### SUMMARY OF THE INVENTION

To overcome these limitations, it is therefore an object of the present invention to provide a fast, convenient process to apply for financial, insurance, investment and business services from a large number of financial, insurance, investment and business service institutions. In accordance with our invention, needless repetitive applications are eliminated.

It is a further object of the present invention to provide a universal financial, insurance, investment and business service application over the Internet and to allow the Inquiring company to submit a single application to a plurality of financial, insurance, investment and business service institutions who then make offers to the inquiring company via the Internet.

To achieve these and other objects of the invention, there is provided a method and apparatus for coordinating an electronic financial, insurance, investment and business service application between an inquiring company and a plurality of financial, insurance, investment and business service institutions via the Internet. The method comprises the steps of displaying a plurality of documents to an inquiring company, receiving a plurality of financial, business structure, industry, Paydex Score and credit data sent from the inquiring company; matching an electronic application to a filter comprising a plurality of selection criteria; transmitting the financial, business structure, industry, Paydex Score and credit data to a plurality of financial, insurance, investment and business service institutions via one of four methods; and responding to the inquiring company via the Internet. The documents sent to the inquiring company includes a series of questions pertaining to said companies desired financial, insurance, investment or business services, followed by the appropriate type of application. The various types of financial, insurance, investment and business service applications include Commercial real estate loan, commercial line of credit, commercial letter of credit, commercial equipment lease, Accounts Receivable Financing, Corporate Credit Card, Merchant Services, 1031 exchange, investment, Directors & Officers Insurance, Errors & Omissions Insurance, Workers Comp. Insurance, Employee Benefit Plans, Cafeteria Plans, Screening & Selection Services, Payroll Services, etc. Other types of applications may exist without departing from the spirit of the invention. Upon completion of the application, the invention matches a unique filter to the financial, business structure, industry, Paydex Score and credit data entered by the Internet inquiring company.

The filter is made up of a plurality of selection criteria in which a specific financial, insurance, investment and business service institution has given to the inventor. The filter is customizable by the specific financial, insurance, investment and business service institution in real time and unique to each financial, insurance, investment and business service institution. Once the application has been filtered, it is sent to a list of financial, insurance, investment and business service institutions that match with the application. These institutions then reply as to whether the application has been accepted or rejected.

The information can be sent in many different ways. For example, the information can be sent in an Active File Transfer system (AFTS), via e-mail, through a secured webpage or through a Common Gateway Interface (CGI). In addition, since much of the information relayed between the network of computers is private information, it is encrypted before it is sent from one computer to another.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings, wherein similar reference characters denote similar elements throughout the several views:

FIG. 1 shows an overview of the method of the invention;

FIG. 2 shows a schematic depiction of network designed to achieve the method of the invention;

FIG. 3a shows the steps involving the second stage of the financial, insurance, investment and business service process;

FIG. 3b shows the steps involving the third stage of the financial, insurance, investment and business service process;

FIG. 4 shows the steps of the fourth stage of the financial, insurance, investment and business service process;

FIG. 5 shows the steps of the fifth stage of the financial, insurance, investment and business service process;

FIG. 6 shows a schematic of the filter process, matching a financial, insurance, investment and business service institution to an inquiring company;

FIG. 7 shows the financial, insurance, investment and business service process where a financial, insurance, investment and business service institution selects from a plurality of inquiring companies;

FIG. 8 shows the steps of the sixth stage of the financial, insurance, investment and business service process;

FIG. 9a shows a schematic of the seventh stage of the financial, insurance, investment and business service process;

FIG. 9b shows the various transfer methods in the eighth stage of the financial, insurance, investment and business service process; and

FIG. 10 shows the steps of the Active File Transfer System in the eighth stage in the of the financial, insurance, investment and business service process;

FIG. 11 shows the steps of the Active File Transfer System in the ninth stage of the financial, insurance, investment and business service process; and

FIG. 12 shows the tenth stage of the financial, insurance, investment and business service process.

### DETAILED DESCRIPTION OF THE PREFERRED EMBODIMENTS

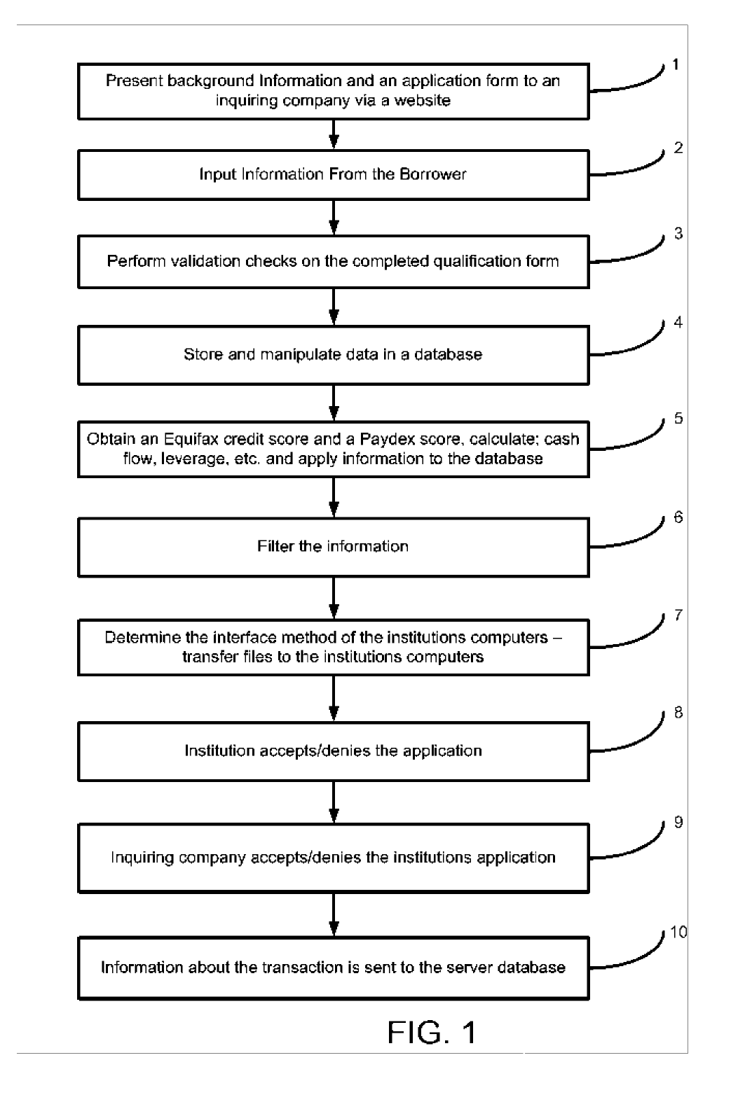

Essentially, the invention is a process and a computer for coordinating financial, insurance, investment and business services between financial, insurance, investment and business service institutions and inquiring companies via the Internet. FIG. 1 illustrates the ten general stages in the process required to coordinate an electronic financial, insurance, investment and business service application between an inquiring company and a plurality of financial, insurance, investment and business service institutions. For example, in stage 1 the process presents background information and a financial, insurance, investment and business service application form to an inquiring company on a web site. In stage 2, the inquiring company inputs information onto the web site. In stage 3, validation checks are performed on this information to make sure that the application is complete and correct. Next, stage 4 involves storing and manipulating the application in a database. In stage 5, an Equifax Credit Score is obtained for the principals of the inquiring company, a Paydex Score is obtained, a cash flow calculation is performed, a leverage calculation is performed, based upon the application form and the scores are matched to the application and stored in the database. Next, in stage 6, the application is filtered where it is compared to a list of criteria presented by a series of financial, insurance, investment and business service institutions based on the facility requested. If the application passes this list of criteria then in stage 7 the application is sent to each one of those institutions whose criteria for the facility requested match with the application. In stage 8 the financial, insurance, investment and/or business service institution processes the application and can either accept or deny it. If the financial, insurance, investment and business service institution accepts the application then in stage 9, the inquiring company can reply stating whether it accepts or denies the financial, insurance, investment and/or business service institutions application. Finally, in stage 10, information about this transaction is sent to a database to allow financial, insurance, investment and business service institutions to have access to their facility history.

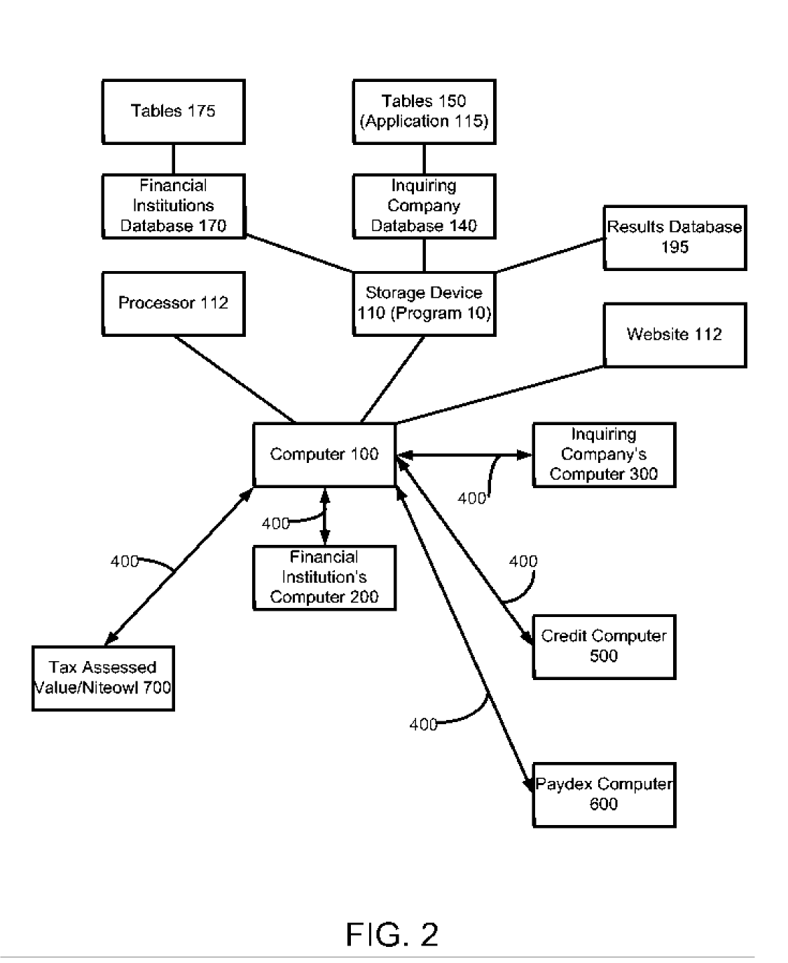

For this process to occur, there must be a series of computers connected to each other via telecommunication lines as shown in FIG. 2. Here, computer program 10, controls the process and is housed on the application forms computer 100. The application forms processing computer 100 coordinates an application between a series of financial, insurance, investment and business service institutions computers 200, and a plurality of inquiring company's computers 300. Computer program 10 is stored on the application forms processing computer 100 in storage device 110 and is run by processor 112. Program 10 is designed to transmit and receive information through the Internet via a web browser such as Netscape or Internet Explorer, installed on the computers.

The application form processing computer 100 must have sufficient memory and processor power to project program 10 over the Internet. Therefore, the recommended minimum requirements for processor 12 on computer 100 is an Intel Pentium 200 Mhz processor. The remaining standard components are 64 megabytes of ram, 2 gigabytes of disk space, an Internet connection, additional Ethernet connection, and Windows NT workstation operating system. Computer 100 is installed with one Ethernet interface directly on the Internet, and the other Ethernet interface connected to a firewall storage device 110, to allow disposition of files on a designated server inside the corporate network. In addition computer 100 could be a Unix style server that interfaces with other Unix and non-Unix based computers on the Internet.

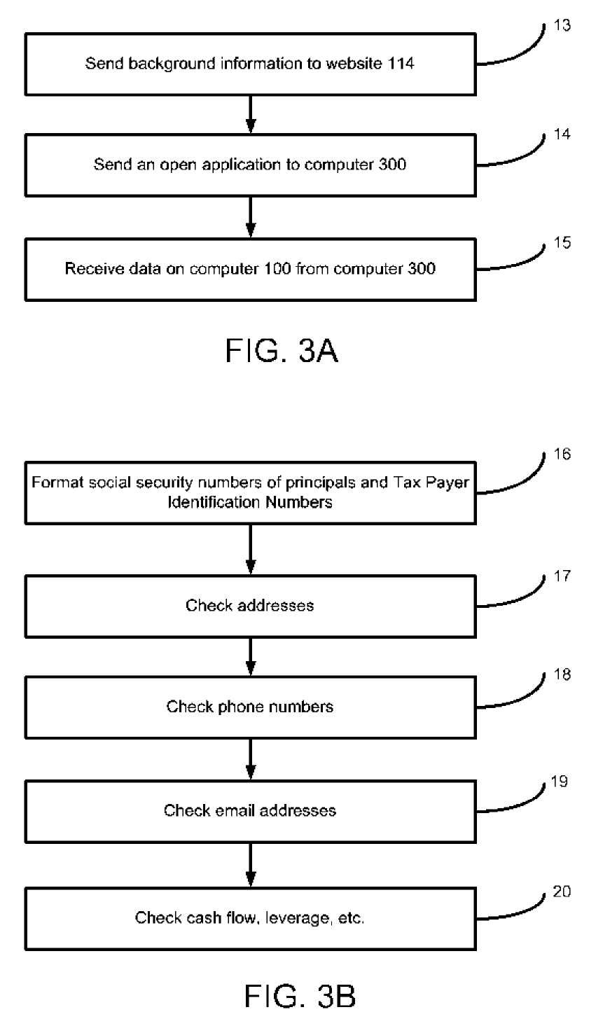

When program 10 runs on computer 100 it instructs computer 100 to interact with other computers through the Internet to co-ordinate a financial, insurance, investment and business service application. For example, as shown in FIGS. 1 and 2, in stage 1, computer 100 allows financial, insurance, investment and business service institutions computers 200 to access information on web-page 114 housed in application form processing computers 100 at a predetermined URL address via telecommunication lines 400. In stage 2, computer 100 allows inquiring company's using satellite computers 300 to view a plurality of documents provided by computer 100. Stage 2 consists of a series of steps that are shown in FIG. 3a. For example, in step 12, computer 100 sends the inquiring company background information documents to web-site 114 concerning the application. These background information documents include a document welcoming the inquiring company to the web site, a document explaining the application process, and a document explaining the services provided. In step 14, computer 100 sends an open application to an inquiring company through the Internet to computer 300. In step 15, the inquiring company inputs information onto the application. When the inquiring company wants to send this information back to computer 100 he clicks a “SEND” button which initiates the third stage of the program.

FIG. 3b outlines stage 3 wherein computer 100 sends a series of instructions to computer 300 to initiate edit and validation checks. In step 16, computer 100 checks the Social Security numbers of the principals and the Tax Identification Number of the inquiring company that have been entered. In step 17 computer 100 checks the addresses, in step 18 it checks phone numbers, in step 19 it checks the email addresses entered, and in step 20 it checks that the cash flow, leverage, and debt service coverage information entered. The edit and validation checks in stage 3 insure that the data to be received by the database 140 in computer 100 is in the proper format for further processing. If computer 100 determines that the data is in the proper format, then the inquiring company can then transmit a completed application 115 to a database on computer 100.

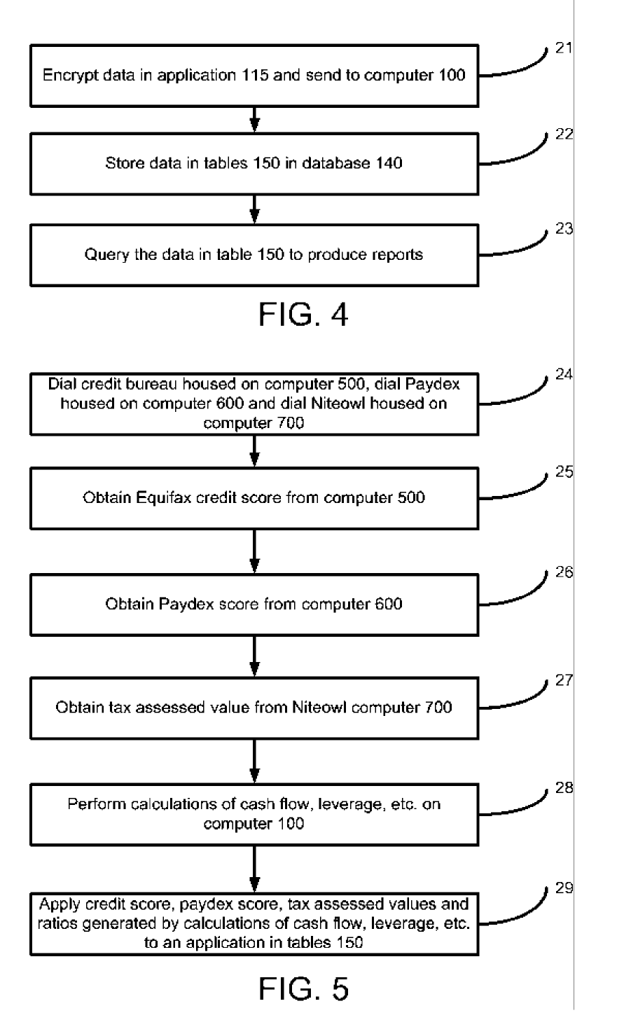

FIG. 4 shows stage 4, wherein in step 21 the data from the completed application 115 is encrypted by SSL technology. Next in step 22, at the inquiring company's instruction, this information is sent to computer 100, unlocked and stored in storage device 110 for further manipulation. In this stage, the data from completed application 115 is sorted and stored in tables 150 in database 140 based on the type facility requested (i.e. Commercial real estate loan, commercial line of credit, commercial letter of credit, commercial equipment lease, Accounts Receivable Financing, Corporate Credit Card, Merchant Services, 1031 exchange, investment, Directors & Officers Insurance, Errors & Omissions Insurance, Workers Comp. Insurance, Employee Benefit Plans, Cafeteria Plans, Screening & Selection Services and Payroll Services, etc.). Next, in step 23, program 10 queries the data from tables 150 to produce reports providing facility information based on data given any field in the application form (i.e., Company name, address, structure, industry, cash flow, leverage, facility requested, etc.).

In FIG. 5, computer 100 moves into stage 5, wherein in step 24, computer 100 dials to credit bureau housed on Credit Computer 500 via telecommunication lines 400. In step 25, computer 100 obtains an Equifax Credit Score from computer 500 based upon the data sent to computer 500. In step 26, computer 100 obtains a Paydex Score from computer 600 based upon the data sent to computer 600. Next, in step 27, computer 100 obtains a Tax Assessed Value of commercial property from Nite Owl computer 700 based upon the data sent to computer 700. Next in step 28, computer 100 performs cash flow, leverage, and debt service coverage calculations with processor 112 based upon the data sent to computer 100. Next in step 29, computer 100 inputs the Equifax Credit Score, the Paydex Score, the Tax Assessed Value, and the cash flow, leverage and debt service coverage calculations to the database tables 150. The financial, insurance, investment and business service institutions can use this Equifax Credit Score, the Paydex Score, the Tax Assessed Value, and the cash flow, leverage and debt service coverage calculations as one determinant to the inquiring company's credit risk.

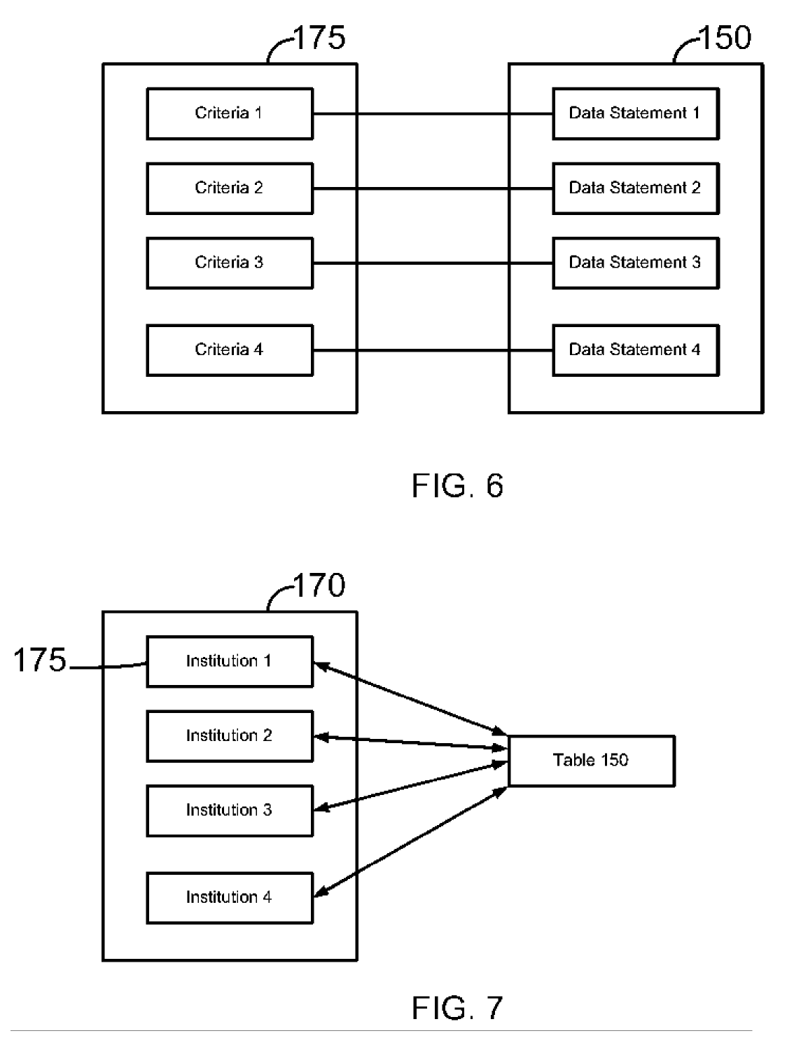

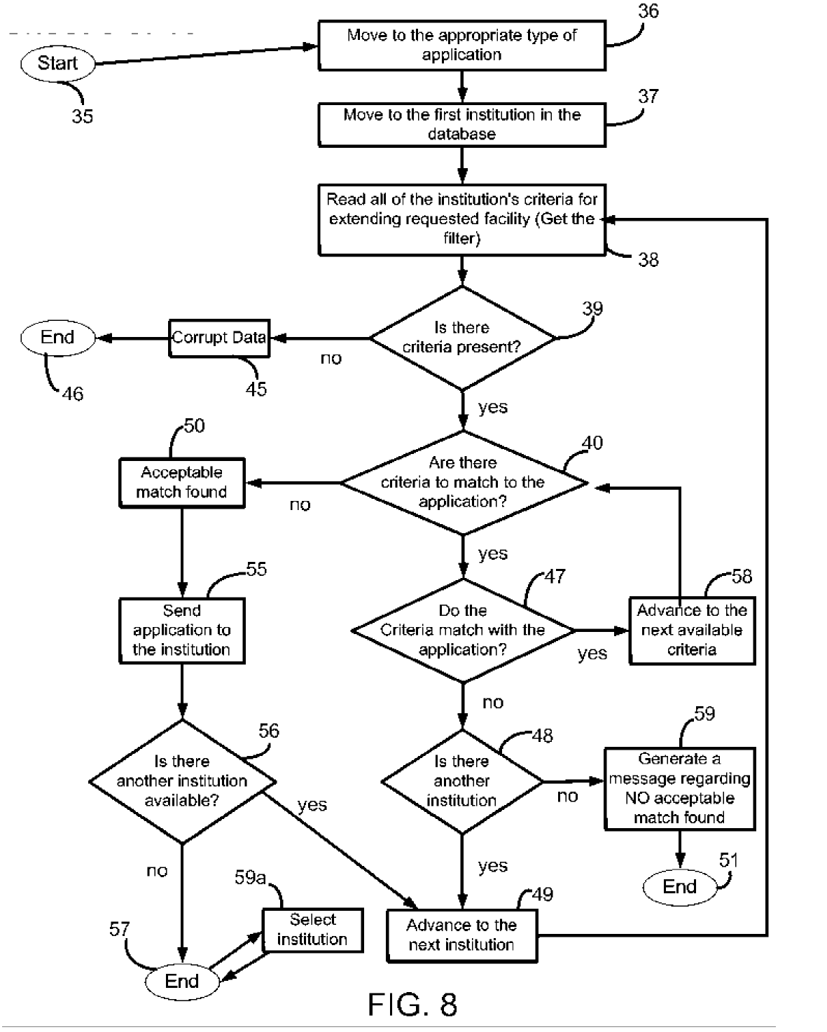

FIGS. 6, 7, and 8 show stage 6 of the process, wherein computer 100 runs a filter to match completed application 115 in table 150 against preset criteria established by each financial, insurance, investment and business service institution. As shown in FIG. 6, individual institution criteria are stored in tables 175 in financial, insurance, investment and business service institution database 170 on computer 100. Wherein in FIG. 7 institution database 170 includes a listing of tables 175 for several financial, insurance, investment and business service institutions. The process for matching inquiring company's application in tables 150 to financial, insurance, investment and business service institutions criteria in tables 175 is shown in FIG. 8. For example, in step 35, program 10 starts the filter process. Next, in step 36, the filter process initiates and moves to the appropriate type application 115 in tables 150. Next, in step 37 the filter moves to a first institution in table 175. In step 38, program 10 instructs computer 100 to read all of the institution's criteria for extending requested facility. In step 39, program 10 reads whether there are any criteria present in tables 175. If the requested data is not present, next, in step 45 the filter checks to see if there is any database connection that is broken and whether the database information in the message. If the criteria are present, step 40 instructs computer 100 to see whether any remaining criteria to match to application 115 stored on tables 150.

If there are more criteria to match to application 115, then in step 47, program 10 checks to see whether that remaining criteria matches with application 115. If the criteria matches with application 115 then in step 58, program 10 advances to the next available criteria in tables 175. As shown in FIG. 6, step 58 creates a loop back to step 40. If the criteria does not match with application 115, then in step 48, program 10 checks to see whether there is another financial, insurance, investment and business service institution in database 170. If there are no remaining financial, insurance, investment and business service institutions in database 170 then in step 59, computer 100 generates a message that no acceptable match has been found. After this message, in step 51, the filter process ends.

If there is another financial, insurance, investment and business service institution found, then the filter process advances to another financial, insurance, investment and business service institution in step 49. Step 49 creates a loop back to step 38 wherein the filter process reads all of the criteria for the new financial, insurance, investment and business service institution. This loop continues until in step 40, the filter finds there are no criteria available to match to completed application 115.

If there are no more criteria to match to application 115, then in step 50, the filter determines whether there has been an acceptable match between an inquiring company and a financial, insurance, investment and business service institution. If there is an acceptable match, then in step 55 the filter selects that institution as a suitable vendor for application 115.

In step 56 program 10 checks to see if there is another financial, insurance, investment and business service institution available, if yes, then program 10 advances to the next institution in step 49. If there are no more institutions available, then program 10 advances to step 57 wherein the filter process ends. Finally in step 59a computer 100 selects a limited number of matched institutions in which to send application 115. For example, if the filter process matches application 115 with 20 institutions, computer 100 may send application 115 to only a fraction of those matched financial, insurance, investment and business service institutions. This selection process in step 58 is based upon either random selection or a predetermined set of criteria stored in computer 100.

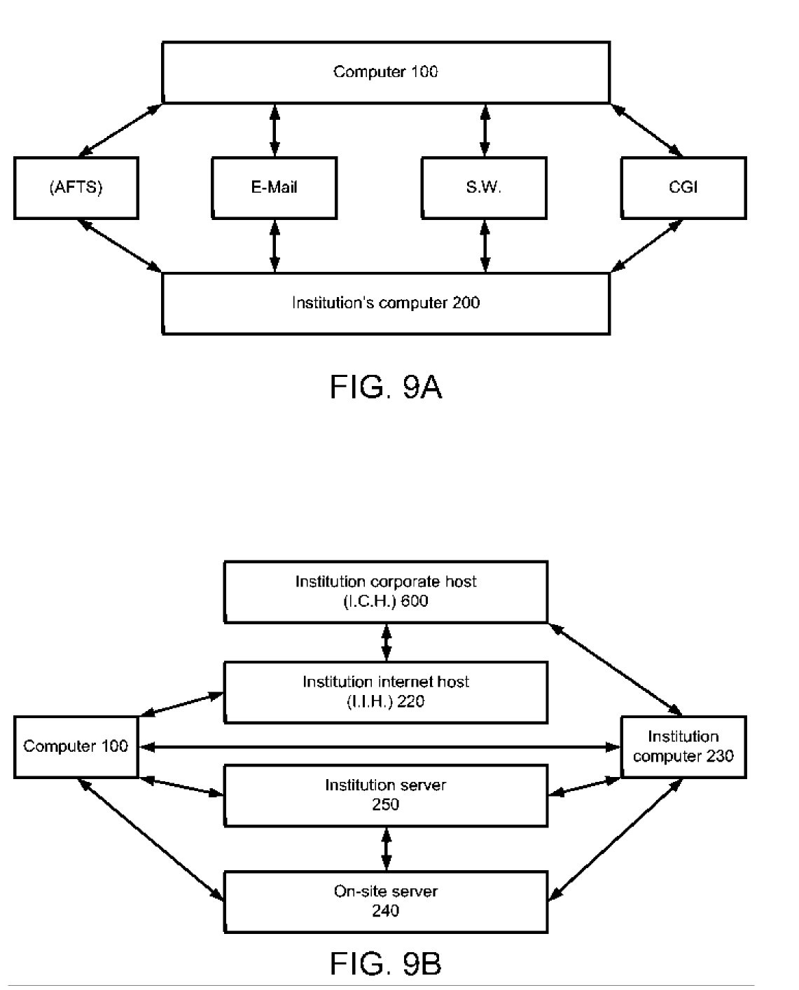

Next, as shown in FIG. 9a in stage 7, program 10 determines the interface method between computer 100 and the selected financial, insurance, investment and business service institution computers 200. The interface method can be Common Gateway Interface (CGI), Active File Transfer (AFTS), as a secured file on a secured webpage (S.W.) or via e-mail. Stage 7 allows loan computer 100 to access many different financial, insurance, investment and business service institution sites which thereby allows for greater communication flexibility within the system.

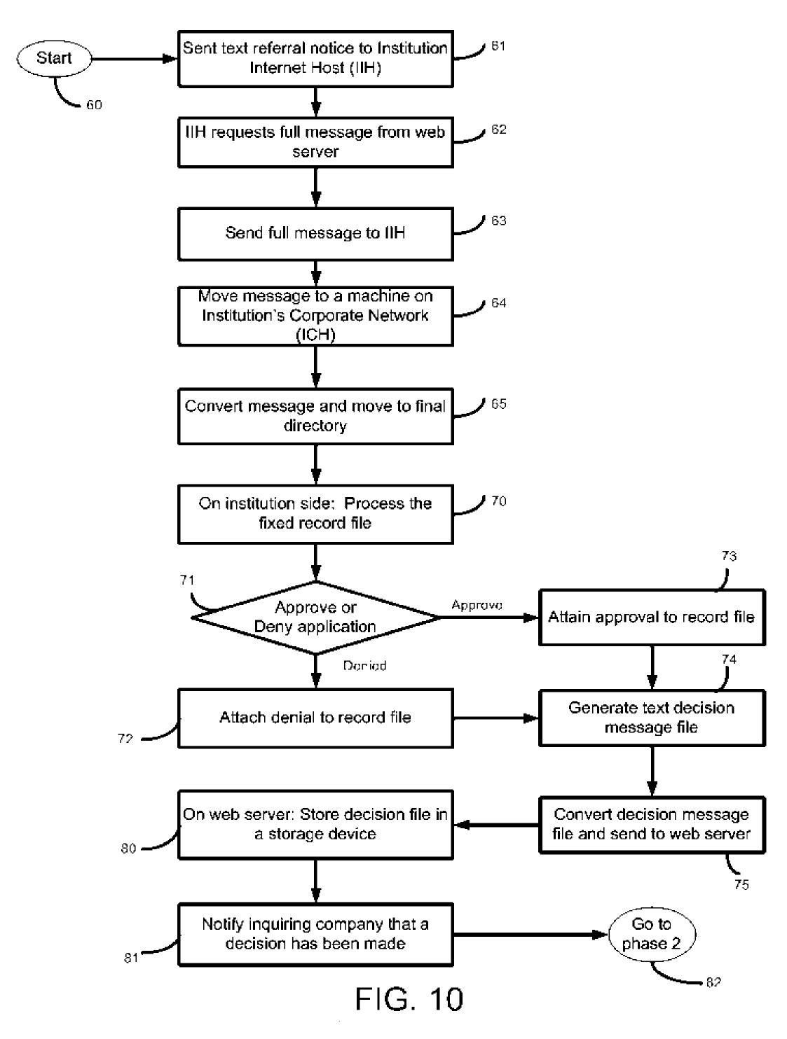

In stage 8, as shown in FIGS. 9a, 9b and 10, computer 100 sends data from table 150 via the interface method selected in stage 7 to the financial, insurance, investment and business service institutions selected in the filter process of stage 6. FIG. 10 shows the Active File Transfer System (AFTS) of FIG. 9b in greater detail. For example, in step 60, program 10 instructs computer 100 to start the AFTS. Next, in step 61 a text referral notice is sent to The Institution Internet Host (IIH) computer 220. In step 62, IIH computer 220 requests a full message from computer 100. In step 63 computer 100 sends an encrypted full message to IIH computer 220. Next, in step 64 computer 200 moves the message to the Institution's Corporate Network (ICH) 600. In step 65, ICH 600 converts the message from HTML format to a customized fixed record format defined and controlled by the destination institution. Next, in step 70, outside program 10, this information can be processed and stored in the institutions system. In step 71 the financial, insurance, investment and business service institution approves or denies application 115. If the institution approves application 115 it attaches an approval to the record file in step 73. Alternatively if the institution denies application 115, then in step 72 it attaches a denial to the record file. In step 74, the institutions computers 700 generate a text decision message file. This message file is converted from the existing format into HTML format and sent to computer 100 web-site via encrypted transmission in step 75. The text decision message file contains a facility id number and a request for more information from the inquiring company. Computer 100 next stores the decision file in database 180 in step 80. Next, in step 81, computer 100 notifies an inquiring company that a decision has been made.

In addition, the data from application 115 can also be sent via e-mail with Pretty Good Privacy (PGP) encryption as shown in FIG. 9b. PGP is an encryption program that can be used to encrypt, a binary file to someone, with very high security, without having to exchange a set of private encryption keys beforehand. In this style transfer system, the text of table 150 comprising facility application 115, is transformed into an e-mail text message. Next, the e-mail message is encrypted in PGP format. Finally, computer 100 sends the e-mail message to computer 230 which is a remote networked computer on a financial, insurance, investment and business service institution's site.

The third transfer process, that of the secured dynamic website serves as a place for financial, insurance, investment and business service institutions to log in to a website to change their facilities criteria filters and to view applications. In this process, information is stored on computer 100 in a website that can be accessed by a financial, insurance, investment and business service institution. To access this site, an individual institution is given a login access account to log into the website that is encrypted by SSL technology. Once the financial, insurance, investment and business service institution logs into the website it can download information relating to an inquiring company's request for information.

In the fourth transfer method, the Common Gateway Interface (CGI) format is shown in FIG. 9b. There, computer 100 sends data from table 150 to institution server 250 via a Common Gateway Interface (CGI) program. CGI programs allow for a server to server interface over which encrypted information can be transferred. For example, the data located on table 150 is first encrypted. Next the data can be sent from computer 100 to institution server 250. Server 250 next stores and unlocks the encrypted data. This unlocked data can then be read by all other networked computers 230 in a financial, insurance, investment and business service institution's home network.

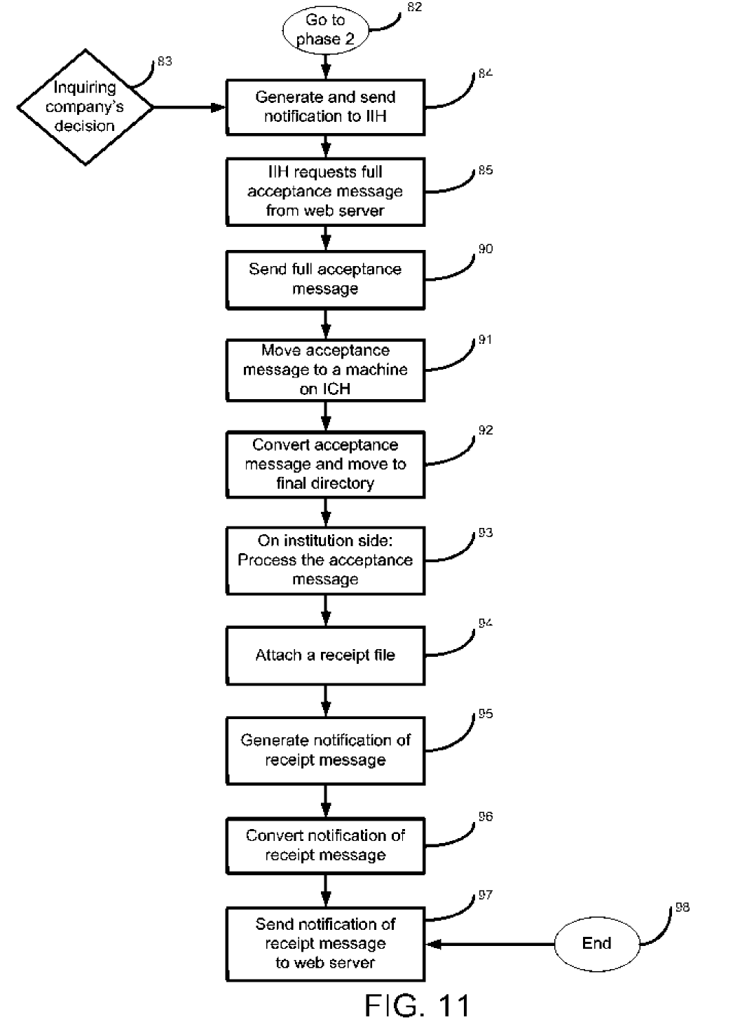

In stage 9, as shown in FIG. 11, computer program 10 moves into the second phase of (AFTS) in step 82. In this stage, the inquiring company informs the financial, insurance, investment and business service institution of its decision concerning the requested facility. For example, in step 83 an inquiring company sends its decision notification from computer 300 to computer 100. Next, in step 84, computer 100 generates and sends a notification to computer 220 (IIH). In step, 85 computer 100 sends a full acceptance message to IIH computer 220 and next moves the acceptance message to ICH computer 600 in step 90. After that, in step 91 ICH computer 600 converts the acceptance message from HTML format and moves it to a final directory 190 on computer 230 (step 91).

At this point the financial, insurance, investment and business service institution program takes over so that in step 93, institution computer 230 processes the acceptance message. In step 94, institution computer 230 attaches a receipt file to the acceptance message. In step 95, institution computer 230 generates a notification of receipt message, and in step 96, it converts the notification from its standard database format into HTML format. Finally, in step 97 ICH computer 600 sends a notification of the receipt message to computer 100 and in step 98 the Active File Transfer System ends.

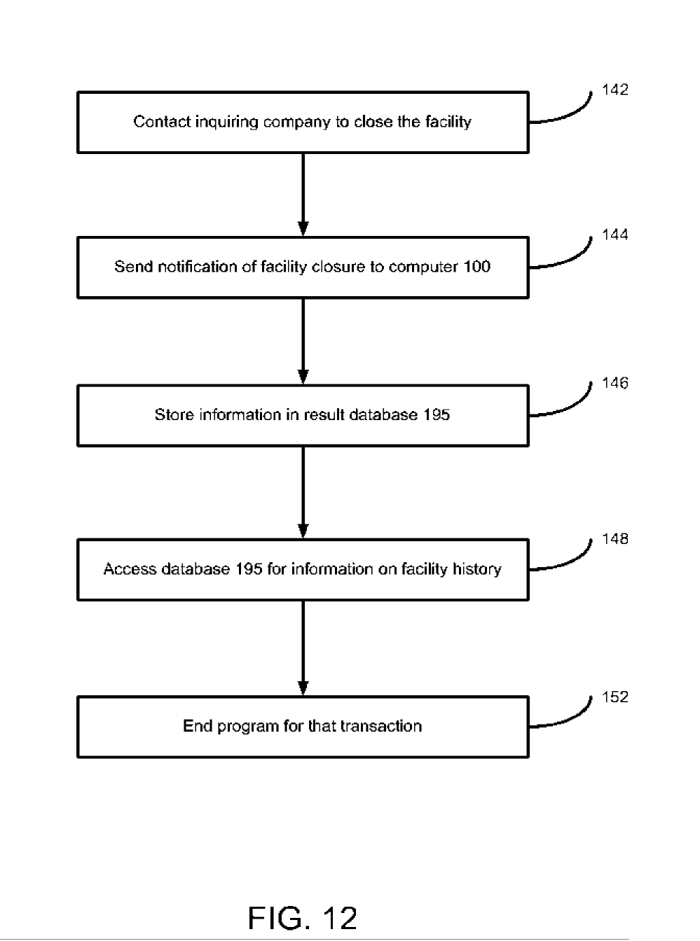

In the tenth and final stage, as shown in FIG. 12, in step 142 the institution contacts the inquiring company to coordinate the closing of the facility. Here, the financial, insurance, investment and business service institution has the inquiring company's Company name, address, structure, industry, cash flow, facility requested, etc. from the acceptance email sent when the offer was accepted. The closing of the requested facility can take place in any way that the financial, insurance, investment and business service institution typically closes said facility. Once all documents are signed and delivered from the inquiring company, the facility is closed. Once the institution closes a facility, in step 144 it contacts computer 100 and sends a notification of the facility closure. In step 146 computer 100 stores this information in result database 195 which can be accessed by the institutions in step 148. Finally in step 152, the process according to the invention ends for that individual transaction.

While several embodiments of the present invention have been shown and described, it is to be understood that many changes and modifications may be made thereunto without departing from the spirit and scope of the invention as defined in the appended claims.

What is claimed is:

1. A method for coordinating an electronic qualification form between a company and a plurality of financial, insurance, investment and business service institutions via a computer network, comprising the steps of:
receiving selection criteria from a plurality of financial, insurance, investment and business service institutions;
receiving financial, business structure, industry, Paydex Score and credit data sent from the company;
employing the selection criteria to filter the financial, business structure, industry, Paydex Score and credit data and to automatically select one or more institutions from the plurality of financial, insurance, investment and business service institutions; and
transmitting the data to each of the selected institutions;
whereby the selected financial, insurance, investment and business service institutions compete with each other for business with the inquiring company.

2. The method of claim 1, further comprising the step of determining an appropriate transfer method to forward the financial, business structure, industry, Paydex Score and credit data to the selected institutions.

3. The method of claim 1, further comprising the step of displaying a plurality of positive financial, business structure, industry, Paydex Score and credit decisions from the selected financial, insurance, investment and business service institutions to the company.

4. The method of claim 4, further comprising the step of assigning each financial, insurance, investment and business service institutions a corresponding filter.

5. The method of claim 4, further comprising the step of customizing selection criteria of each filter in response to receiving communications from a corresponding financial, insurance, investment and business service institutions.

6. The method of claim 1, wherein the step of receiving financial, business structure, industry, Paydex Score and credit data further comprises receiving financial, business structure, industry, Paydex Score and credit data from the company comprising information relating to one of a Commercial real estate loan, commercial line of credit, commercial letter of credit, commercial equipment lease, Accounts Receivable Financing, Corporate Credit Card, Merchant Services, 1031 exchange, investment, Directors & Officers Insurance, Errors & Omissions Insurance, Workers Comp. Insurance, Employee Benefit Plans, Cafeteria Plans, Screening & Selection Services and Payroll Services.

7. A method for coordinating business between a company and a plurality of financial, insurance, investment and business service institutions via a computer network, comprising the steps of:
storing selection criteria for a plurality of financial, insurance, investment and business service institutions;
receiving financial, business structure, industry, Paydex Score and credit data sent from the computer user corresponding to an electronic qualification/application form;
matching the financial, business structure, industry, Paydex Score and credit data with financial, insurance, investment and business service institutions and the selection criteria by employing the selection criteria to filter the financial, business structure, industry, Paydex Score and credit data and to automatically select one or more financial, insurance, investment and business service institutions from the plurality of financial, insurance, investment and business service institutions;
determining an appropriate transfer method to transmit said electronic qualification form to the financial, insurance, investment and business service institutions associated with a match of said financial, business structure, industry, Paydex Score and credit data;
transmitting the electronic qualification form to the financial, insurance, investment and business service institutions associated with a match of said financial, business structure, industry, Paydex Score and credit data according to the determined transfer method;
whereby the selected financial, insurance, investment and business service institutions compete with each other for business with the inquiring company by electing to make offers to the inquiring company.

8. The method of claim 7, further comprising the step of displaying one or more positive decisions from the selected financial, insurance, investment and business service institutions to the company.

9. The method of claim 7, further comprising transmitting said electronic qualification form to said financial, insurance, investment and business service institutions associated with a match of said financial, business structure, industry, Paydex Score and credit data via a Common Gateway Interface (CGI).

10. The method of claim 7, further comprising transmitting said electronic qualification form to said financial, insurance, investment and business service institutions associated with a match of said financial, business structure, industry, Paydex Score and credit data via a secured website.

11. The method of claim 7, further comprising transmitting said qualification form to said financial, insurance, investment and business service institutions associated with a match of said financial, business structure, industry, Paydex Score and credit data via a secured E-Mail.

12. A method for promoting commerce between a company and a plurality of financial, insurance, investment and business service institutions via a computer network, comprising the steps of:
receiving selection criteria from a plurality of financial, insurance, investment and business service institutions;
receiving financial, business structure, industry, Paydex Score and credit data sent from the inquiring company;
matching the data with financial, insurance, investment and business service institutions and the selection criteria;
transmitting the data to one or more financial, insurance, investment and business service institutions associated with a match of the financial, business structure, industry, Paydex Score and credit data; and
displaying a plurality of positive decisions from one or more of the financial, insurance, investment and business service institutions to the inquiring company or a website via the computer network.

13. The method of claim 11, wherein the step of matching the data comprises employing the selection criteria to filter the data and to automatically select one or more financial, insurance, investment and business service institutions from the plurality of financial, insurance, investment and business service institutions.

14. The method of claim 11, further comprising the step of determining an appropriate transfer method to transmit the financial, business structure, industry, Paydex Score and credit data to the institutions associated with a match of said data.

15. The method of 14, further comprising the step of transmitting the financial, business structure, industry, Paydex Score and credit data to the financial, insurance, investment and business service institutions associated with a match of said data according to the determined transfer method.

16. The method of claim 11, further comprising the step of receiving via the computer network at least one decision from the company regarding at least one of the positive decisions, the companies decision comprising an acceptance, denial or request for more information regarding a positive decision for one of said financial, insurance, investment and business service institutions associated with a match of said data.

17. The method of claim 11, further comprising the step of transmitting a companies decision regarding a positive decision to at least one financial, insurance, investment and business service institution corresponding with the positive financial, business structure, industry, Paydex Score and credit data decision so that said company can obtain application/contract forms from one of said institutions associated with a match of said data.

18. A computer readable medium having computer-executable instructions for coordinating an electronic financial, insurance, investment or business service application between a company and a plurality of financial, insurance, investment and business service institutions via the Internet, the instructions comprising the steps of:
receiving selection criteria from one or more financial, insurance, investment and business service institutions;
receiving financial, business structure, industry, Paydex Score and credit data from the company;
applying the financial, business structure, industry, Paydex Score and credit data to a filter comprising a plurality of selection criteria to automatically select each one of the financial, insurance, investment and business service institutions associated with a match of the data to the selection criteria;
transmitting the financial, business structure, industry, Paydex Score and credit data to the selected ones of the institutions to assist a determination of offering financial, insurance, investment and business services to the inquiring company; and
coordinating communication between the selected institutions and the company so that the company can accept services from one of the selected institutions.

19. The computer readable medium of claim 18, wherein the step of coordinating communication further comprises the step of receiving a decision from the company regarding one or more offers made from the selected ones of the financial, insurance, investment and business service institutions.

20. The computer readable medium of claim 18, further comprises the step of displaying one or more positive decisions from the selected institutions to the company.

21. The computer readable medium of claim 18, wherein the financial, insurance, investment and business services comprise services relating to one of Commercial real estate loan, commercial line of credit, commercial letter of credit, commercial equipment lease, Accounts Receivable Financing, Corporate Credit Card, Merchant Services, 1031 exchange, investment, Directors & Officers Insurance, Errors & Omissions Insurance, Workers Comp. Insurance, Employee Benefit Plans, Cafeteria Plans, Screening & Selection Services, Payroll Services, etc.

22. A system for coordinating business between a company and a plurality of financial, insurance, investment and business service institutions; a processing unit;
a memory storage device;
and a program module, stored in said memory storage device for providing instructions to said processing unit;
said processing unit responsive to said instructions of said program module, operable for receiving selection criteria from a plurality of financial, insurance, investment and business service institutions;
receiving financial, business structure, industry, Paydex Score and credit data sent from the company;
employing the selection criteria to filter the financial, business structure, industry, Paydex Score and credit data and to automatically select one or more financial, insurance, investment and business service institutions from the plurality of financial, insurance, investment and business service institutions;
and forwarding the financial, business structure, industry, Paydex Score and credit data to the selected one or more financial, insurance, investment and business service institutions; whereby the selected institutions compete with each other for business with the inquiring company.

23. The system of claim 22, wherein said processing unit is further operable for determining an appropriate transfer method to forward the financial, business structure, industry, Paydex Score and credit data to the selected financial, insurance, investment and business service institutions.

24. The system of claim 22, wherein said processing unit is further operable for displaying a plurality positive decisions from the selected financial, insurance, investment and business service institutions to the company.
